(19) United States
(12) Patent Application Publication
(10) Pub. No.: US 2026/0088724 A1
(43) Pub. Date: Mar. 26, 2026

(54) CONTROL OF A RESONANT CONVERTER USING SWITCH PATHS DURING POWER-UP

(71) Applicant: POWER INTEGRATIONS, INC., SAN JOSE, CA (US)

(72) Inventors: Robert J. MAYELL, Los Altos, CA (US); Yueming WANG, Milpitas, CA (US); Hartley HORWITZ, Ottawa (CA); Paul DEMONE, Kanata (CA)

(73) Assignee: POWER INTEGRATIONS, INC., SAN JOSE, CA (US)

(21) Appl. No.: 19/405,262

(22) Filed: Dec. 1, 2025

Related U.S. Application Data
(63) Continuation of application No. 17/783,618, now Pat. No. 12,537,454.
(60) Provisional application No. 62/948,444, filed on Dec. 16, 2019.

(51) Int. Cl. H02M 3/335; H02M 1/00; H02M 1/08; H02M 1/36; H02M 3/00

(52) U.S. Cl. CPC H02M 3/33571; H02M 1/0006; H02M 1/08; H02M 1/36; H02M 3/01

(57) ABSTRACT

A half-bridge circuit of a power converter includes a high-side device and a low-side device coupled together at a half-bridge node, which is in turn coupled to a network including an inductor and/or a capacitor. In some examples, the network is a resonant network. The half-bridge circuit further includes a first switch and a second switch. The first switch is coupled between the half-bridge node and a ground reference, in parallel with the low-side device. The second switch is coupled between an input node of the power converter and the half-bridge node, in series with a high-side capacitor that powers a driver of the high-side device. During power-up, the second switch turns on to provide a charging current to the high-side capacitor, while the first switch turns on to augment the charging current by pulling down a voltage at the half-bridge node, thereby diverting a shunt current away from the network.

### CROSS-REFERENCE TO RELATED APPLICATIONS

This application is a continuation of U.S. patent application Ser. No. 17/783,618, filed Jun. 8, 2022, which is a National Stage Entry of International Application No. PCT/US2020/065074, filed Dec. 15, 2020, which claims the benefit of U.S. Provisional Application No. 62/948,444, filed Dec. 16, 2019. The contents of each of the above-listed applications are incorporated by reference herein in their entirety.

### FIELD OF DISCLOSURE

The present disclosure relates generally to power converters, and more specifically to powering on resonant converters.

### BACKGROUND INFORMATION

Electronic devices use power to operate. Switched mode power converters are commonly used due to their high efficiency, small size and low weight to power many of today's electronics. Conventional wall sockets provide a high voltage alternating current. In a switching power converter, a high voltage alternating current (ac) input is converted to provide a well-regulated direct current (dc) output through an energy transfer element. The switched mode power converter controller usually provides output regulation by sensing one or more inputs representative of one or more output quantities and controlling the output in a closed loop. In operation, a switch is utilized to provide the desired output by varying the duty cycle (typically the ratio of the on time of the switch to the total switching period), varying the switching frequency, or varying the number of pulses per unit time of the switch in a switched mode power converter.

One type of switch mode power converter is a resonant converter, which includes a resonant circuit (e.g., inductor(s) and capacitor(s)) as part of a power stage. A resonant circuit may advantageously enhance power conversion efficiency by availing zero-current and/or zero-voltage switching.

A subset of resonant converters, the series inductor-inductor capacitor (LLC) converter, uses a resonant circuit with two inductors and one capacitor connected in series to form an LLC resonant circuit. Commonly, the power stage of an LLC converter is controlled so that power stage switches undergo zero-voltage switching.

### BRIEF DESCRIPTION OF THE DRAWINGS

Non-limiting and non-exhaustive embodiments for control of a resonant converter using switch paths during power-up are described with reference to the following figures, wherein like reference numerals refer to like parts throughout the various views unless otherwise specified.

FIG. 1A illustrates a simplified schematic of an LLC converter according to an embodiment.

FIG. 1B illustrates a simplified schematic of an LLC converter according to another embodiment.

FIG. 2A is a schematic of a half-bridge circuit including switch paths according to a first embodiment.

FIG. 2B is a schematic of a half-bridge circuit including switch paths according to a second embodiment.

FIG. 2C is a schematic of a half-bridge circuit including switch paths according to a third embodiment.

FIG. 2D is a schematic of a half-bridge circuit including switch paths according to a fourth embodiment.

FIG. 3A illustrates a control circuit according to an embodiment.

FIG. 3B illustrates a control circuit according to an embodiment.

FIG. 3C illustrates a control circuit according to an embodiment.

FIG. 3D illustrates a control circuit according to an embodiment.

FIG. 4 illustrates a schematic of a half-bridge circuit according to an embodiment.

FIG. 5 illustrates waveforms according to an embodiment.

FIG. 6A illustrates a conceptual block diagram for operating a resonant converter during a power-up state according an embodiment.

FIG. 6B illustrates a conceptual block diagram for operating a resonant converter during a power-up state according to the embodiment of FIG. 6A.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the teachings herein.

### DETAILED DESCRIPTION

In the following description, numerous specific details are set forth in order to provide a thorough understanding of control of a power converter using switch paths during power-up. It will be apparent, however, to one having ordinary skill in the art that the specific detail need not be employed to practice the teachings herein. In other instances, well-known materials, components, and/or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the teachings herein. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

In the context of the present application, when a transistor is in an “off-state” or “off” the transistor blocks current and/or does not substantially conduct current. Conversely, when a transistor is in an “on-state” or “on” the transistor is able to substantially conduct current. By way of example, in one embodiment, a high-voltage transistor comprises an N-channel field-effect transistor (FET); the N-channel field-effect transistor (FET) may be a metal oxide semiconductor field effect transistor (MOSFET) with the high-voltage being supported between the first terminal, a drain, and the second terminal, a source. In another embodiment the field-effect transistor (FET) may be a junction field effect transistor (JFET), a depletion-mode device whereby transport is predominantly by majority carriers.

In some embodiments an integrated controller circuit may be used to drive a power switch when regulating energy provided to a load. Also, for purposes of this disclosure, “ground” or “ground potential” refers to a reference voltage or potential against which all other voltages or potentials of an electronic circuit or Integrated circuit (IC) are defined or measured.

As described above one type of switched mode power converter is a resonant converter which uses a resonant circuit, also referred to as a resonant network or “tank” circuit, having inductance(s) and capacitance(s) as part of the power conversion process. Resonant converters may have some advantages compared to non-resonant switched mode power converters, such as soft switching (e.g., zero-voltage switching), generally higher efficiency, lower losses at higher frequency operation, and lower harmonic content in switching waveforms. These in turn can reduce packaging and component costs by allowing the use of smaller magnetic elements and smaller electromagnetic interference (EMI) filters.

Resonant converters often include a half-bridge circuit. The half-bridge circuit may include a low-side device driven by a low-side driver and a high-side device driven by a high-side driver. Under steady state switching conditions (i.e., under steady state conditions), the high-side driver may use a high-side capacitor, often referred to as a bootstrap capacitor, to cyclically provide power to the high-side driver. Additionally, the low-side driver may use a low-side capacitor, referred to as a holding capacitor, to maintain power to the low-side driver.

As one of ordinary skill in the art may appreciate, bootstrap circuitry may be required to avail a bootstrap voltage to the bootstrap capacitor. For instance, power (i.e., charge) may be provided to a high-side driver and its bootstrap capacitor by using a switching bootstrap method. In the steady state (i.e., during steady state operating conditions), the switching bootstrap method may cyclically provide energy to the bootstrap capacitor in accordance with a steady state switching cycle. When the low-side device is on, charge may be replenished from a ground referenced power source, via a bootstrap device (e.g., a bootstrap diode and/or an FET).

The capacitance of the high-side capacitor and the capacitance of the low-side capacitor may be selected to assure sufficient power during steady state switching and also during light-load conditions. For instance, the capacitances may be selected to be larger than a minimum holding capacitance (e.g., one hundred nanofarads) to hold sufficient voltage and to provide sufficient power to the high-side driver and/or the low-side driver.

Resonant converters may also include a resonant network (i.e., a resonant circuit). For instance, a resonant converter may use a resonant network including two inductors and a resonant capacitor to form an LLC (inductor-inductor-capacitor) resonant converter. Moreover, the inductances and capacitance of the resonant network may be designed for a desired operating point, gain, and performance specification. Accordingly, the capacitance of the resonant capacitor may be constrained by design.

Successful transition to the steady state from power-up may further depend upon a ratio of the capacitance of the resonant capacitor to the capacitance of the high-side capacitor. For instance, during power-up, the high-side capacitor and the resonant capacitor may be electrically coupled in a circuit path; and a high-side voltage (i.e., a bootstrap voltage) across the high-side capacitor may be limited by virtue of a capacitive voltage divider formed by the high-side capacitor with the resonant capacitor. Traditionally, a solution to assuring sufficient bootstrap voltage is to limit the capacitance of the high-side capacitor relative to that of the resonant capacitor.

Unfortunately, it may be undesirable to limit the capacitance of the high-side capacitor. Accordingly, there is a need for a half-bridge circuit which can successfully power-up to the steady state regardless of the capacitance of the resonant capacitor. Moreover, there is a need for a half-bridge circuit which can successfully power-up to the steady state regardless of the ratio of the capacitance of the resonant capacitor with the capacitance of the high-side capacitor.

Additionally, as modern switching converters and modern LLC converters seek to operate at higher switching frequencies, there is a need to improve and enhance power-up and power-up sequencing. For instance, during power-up, there may be unbalanced, unknown conditions (e.g., internal and/or external initial conditions), which can give rise to damaging overstress, to damaging inrush currents, and/or to slow response time in reaching steady-state zero-voltage switching. Unfortunately, the goal to operate at higher frequency may lead to unbalanced initial conditions. Accordingly, there is also a need for a half-bridge circuit which can successfully power-up to the steady state without electrically overstressing components.

Control of a resonant power converter using switch paths during power-up is described herein. During power-up, a first switch path sinks current away from a resonant capacitor while a second switch path sources current to a high-side capacitor. In this way the high-side capacitor may predictably charge to sufficient bootstrap voltage to support steady state operation. Additionally, a third switch path may control current to a low-side capacitor.

According to the teachings herein, the switch paths may advantageously enhance an LLC converter's ability to achieve steady state and rapidly attain zero voltage switching by reducing the transient time required to reach steady state. Additionally, using switch paths may avail a controllable and repeatable power-up method to advantageously reduce stress (i.e., overcurrent and/or overvoltage stress) on the high-side driver and low-side driver.

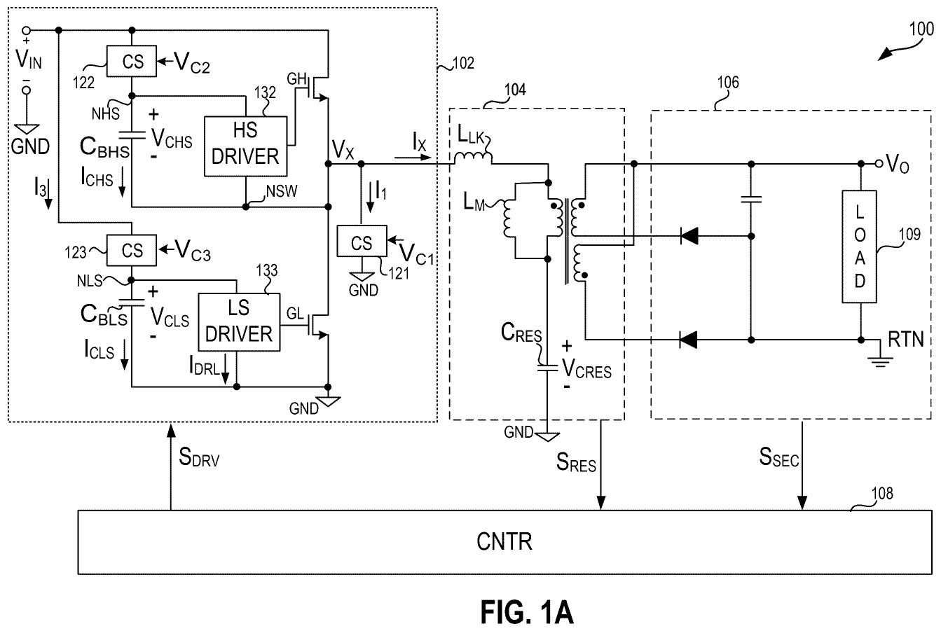

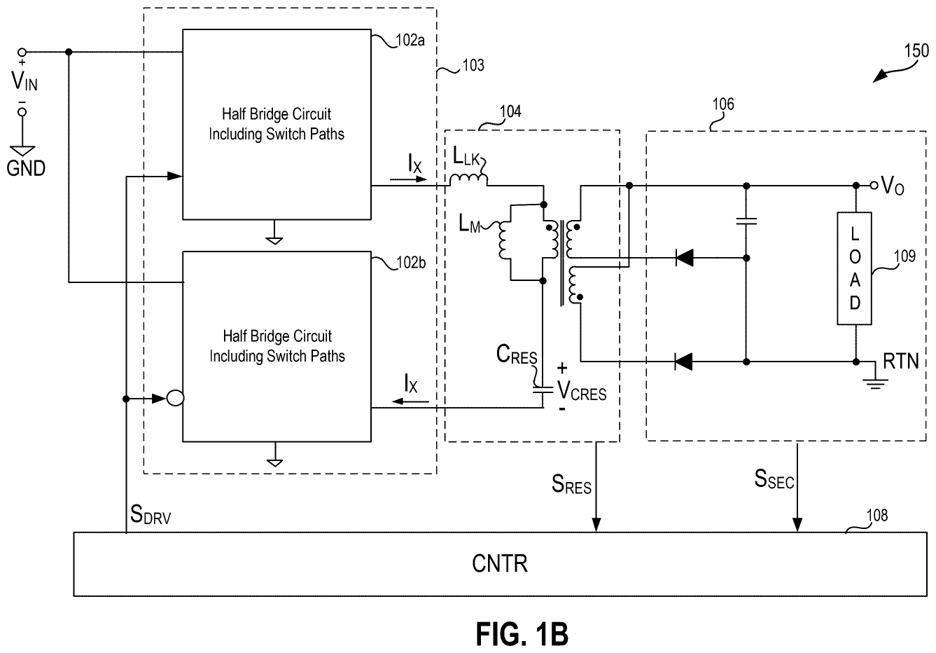

FIG. 1A illustrates a schematic of an LLC converter 100 according to an embodiment. The LLC converter 100 includes a half-bridge circuit 102, a resonant network 104, a secondary network 106, and a controller 108. A direct current (dc) input voltage VIN, referenced to ground GND, may be applied at a primary input of the LLC converter 100 as a source of input power. In the steady state the controller 108 may control the LLC converter 100 to convert input power into de output power delivered to a load 109. For ease of presentation, the schematic of the LLC converter 100 has been simplified to provide a less obstructive view of switch paths 121-123.

As illustrated, the half-bridge circuit 102 includes a first switch path 121, a second switch path 122, and a third switch path 123. The first switch path 121 receives a control signal V_{C1}. The second switch path 122 receives a control signal V_{C2}; and the third switch path 123 receives a control signal V_{C3}. As described herein, the switch paths 121-123 may be controlled by their respective control signals V_{C1}-V_{C3} to assure transition to the steady state from power-up (i.e., from a power-up state).

In the steady state (i.e., during steady state switching conditions) the LLC converter 100 may regulate the dc output power delivered to a load 109. The dc output power may be delivered to the load 109 with a regulated output voltage V_{O} relative to a secondary ground RTN. Also, during the steady state, the controller 108 may provide a primary drive signal S_{DRV} to the half-bridge circuit 102. Moreover, the primary drive signal S_{DRV} may be provided in response to a secondary signal S_{SEC} and/or a resonant network signal S_{RES} to regulate de output power delivered to the load 109.

As illustrated, the half-bridge circuit 102 includes a high-side capacitor C_{BHS} and a low-side capacitor C_{BLS}; and the resonant network 104 includes a leakage inductor L_{LK}, magnetizing inductor L_{M}, and resonant capacitor C_{RES}. Also as illustrated, the high-side capacitor C_{BHS}, low-side capacitor C_{BLS}, and resonant capacitor C_{RES} may operate with voltages V_{CHS}, V_{CLS}, and VC_{RES}, respectively. The high-side capacitor C_{BHS} may also be referred to as a bootstrap capacitor C_{BHS}; and voltage V_{CHS} may be referred to as bootstrap voltage V_{CHS}. Similarly, the low-side capacitor C_{BLS} may also be referred to as a low-side holding capacitor C_{BLS}; and voltage V_{CLS} may be referred to as low-side holding voltage V_{CLS}.

As one of ordinary skill in the art may appreciate, a resonant tank frequency may be determined, at least in part, by the capacitance of the resonant capacitor C_{RES} with the inductance of the leakage inductor L_{LK} and/or the magnetizing inductor L_{M}. In the steady state, a current I_{X} may be provided to the resonant network 104 as an alternating current having a frequency commensurate with that of the resonant tank frequency; and the voltage VC_{RES} may vary in proportion to the current I_{X}.

Also as illustrated, half-bridge circuit 102 includes a high-side driver 132 and a low-side driver 133. The high-side driver 132 is electrically coupled to a first terminal of the high-side capacitor C_{BHS} at a high-side node NHS, and further coupled to a second terminal of the high-side capacitor C_{BHS} at a half-bridge switch node NSW. When sufficient voltage V_{CHS} (e.g. ten volts) is available from the high-side capacitor C_{BHS}, the high-side driver 132 may provide a gate signal GH. The low-side driver 133 is electrically coupled to a first terminal of the low-side capacitor C_{BLS} at a low-side node NLS, and further coupled to a second terminal of the low-side capacitor C_{BLS} at ground GND. When sufficient voltage V_{CLS} (e.g. ten volts) is available from the low-side capacitor C_{BLS}, the low-side driver 133 may provide a gate signal GL.

During power-up (i.e., in the power-up state), the voltages V_{CHS} and V_{CLS} may have transient values (i.e., transient voltage levels) whereby the high-side driver 132 and/or the low-side driver 133 do not have sufficient power (i.e., voltage and/or energy) to provide adequate gate signals GH, GL. According to the teachings herein, the first switch path 121 may shunt (i.e., sink) current I₁ away from the resonant capacitor C_{RES} while second switch path 122 provides (i.e., sources) current I_{CHS} to the high-side capacitor C_{BHS}. For instance, the first switch path 121 may divert current I₁ to enhance (i.e., to augment) current I_{CHS}. In this manner the aforementioned capacitive voltage divider, formed by the high-side capacitor C_{BHS} with the resonant capacitor C_{RES}, may be substantially eliminated during power-up. Consequently, during power-up, the high-side capacitor C_{BHS} may be advantageously charged (i.e., augmented) to a voltage V_{CHS} (i.e., bootstrap voltage V_{CHS}) adequate for powering the high-side driver 132.

Additionally, the third switch path 123 may provide (i.e., source) current I_{CLS} to the low-side capacitor C_{BLS} so that the low-side holding voltage V_{CLS} reaches a steady state value in a controlled manner.

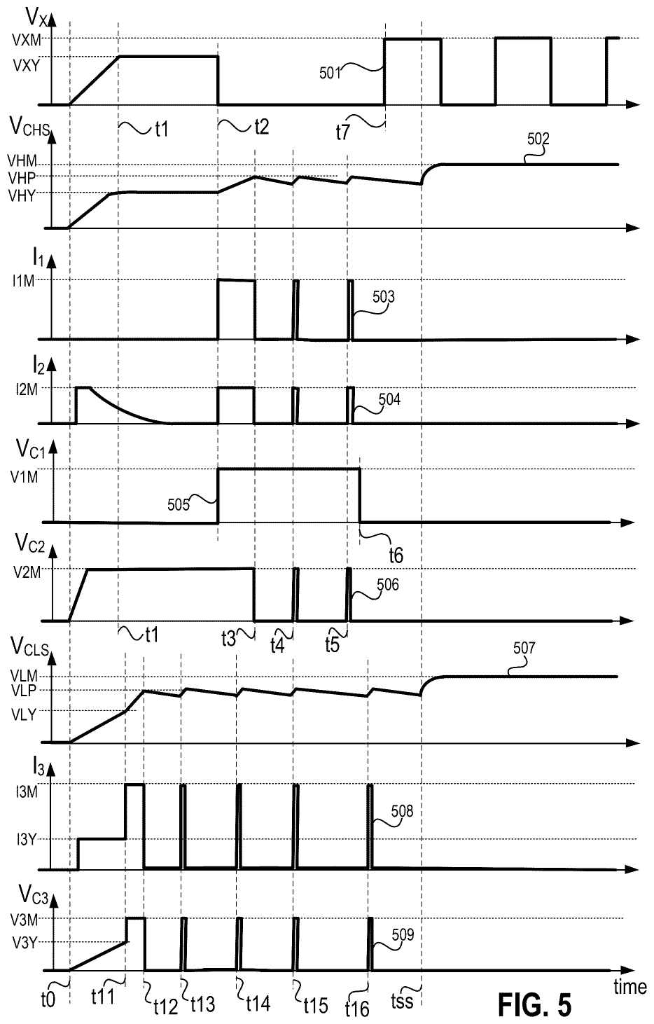

Alternatively, and additionally, the third switch path 123 may provide current I_{CLS} to the low-side capacitor C_{BLS} as a function of the low-side holding voltage V_{CLS}. As discussed below with respect to FIG. 5, the third switch path 123 may limit and/or control current I₃ to follow a function of the low-side holding voltage V_{CLS}. Controlling current I₃ as a function of holding voltage V_{CLS} may advantageously reduce thermal stress and/or thermal failures due to faults (e.g., a short-circuit fault).

As mentioned above, the schematic of the LLC converter 109 is a non-limiting embodiment simplified to provide a less obstructive view of switch paths 121-123. For instance, the controller 108 has been simplified to show only three signals, namely, the primary drive signal S_{DRV}, the secondary signal S_{SEC}, and the resonant network signal S_{RES}.

As one of ordinary skill in the art may appreciate, the half-bridge circuit 102 may be used in other converter architectures including inductor-capacitor-capacitor (LCC) resonant converters and/or various non-resonant converters. As one of ordinary skill in the art may appreciate, controller 108 may exert control with greater or fewer than three signals; and other configurations are possible.

For instance, FIG. 1B illustrates a simplified schematic of an LLC converter 150 according to another embodiment. The LLC converter 150 is similar to LLC converter 100, except the half-bridge circuit 102 is replaced with a full-bridge circuit 103. The full-bridge circuit 103 includes half-bridge circuits 102a-102b. The half-bridge circuits 102a-102b may be similar to half-bridge circuit 102 and may each include switch paths (e.g., switch paths 121-123).

As one of ordinary skill in the art may appreciate, the LLC converter 150 is connected in a full-bridge configuration whereby the resonant network 104 is electrically coupled between the half-bridge circuits 102a-102b. As illustrated, in a full-bridge configuration current Ix is provided to the resonant network 104 from half-bridge circuit 102a; and current Ix is provided from the resonant network 104 to the half-bridge circuit 102b.

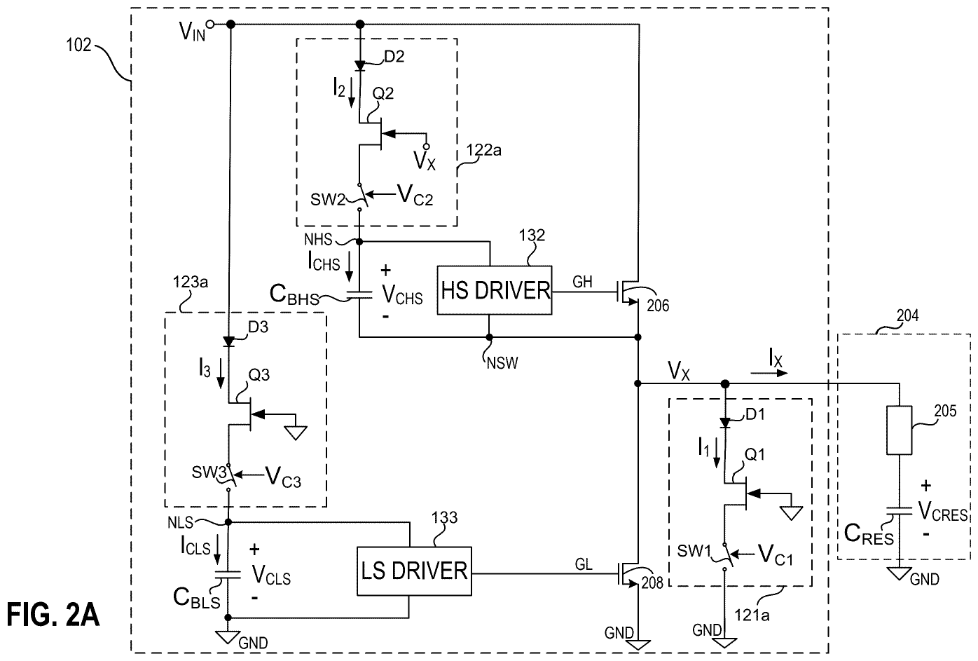

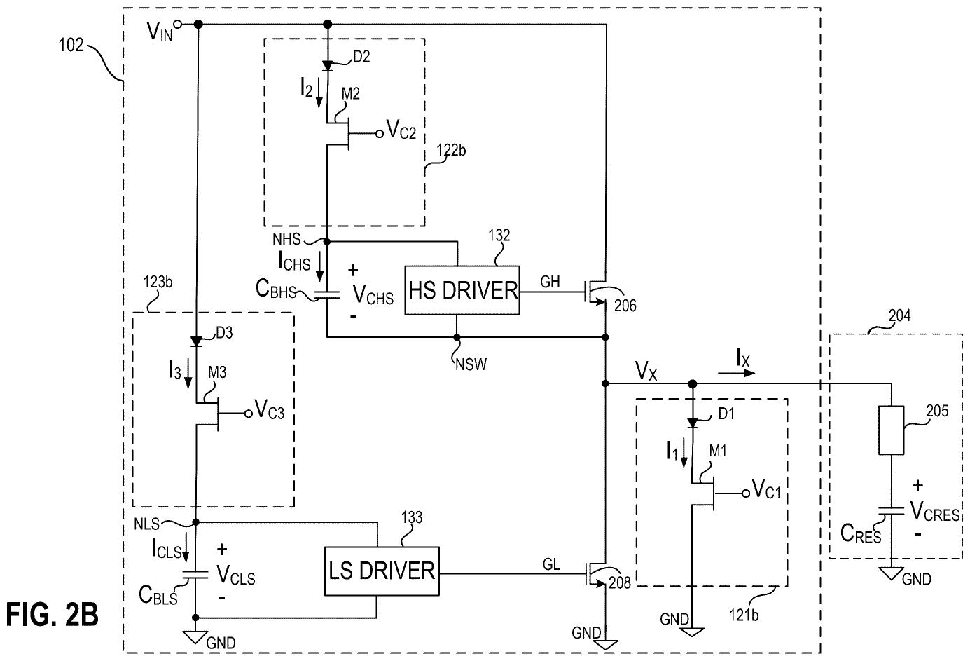

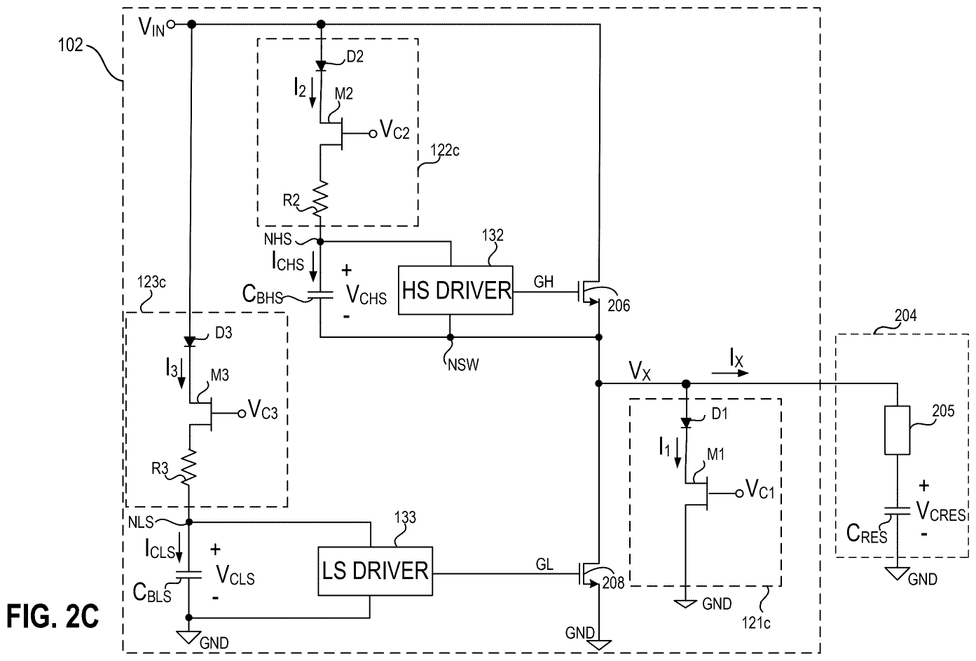

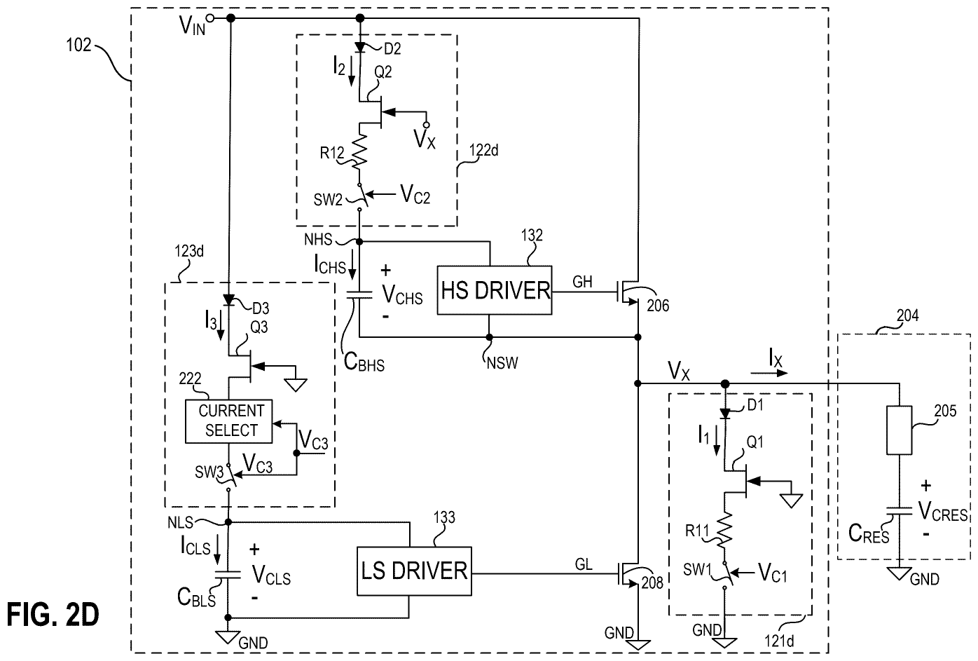

FIG. 2A is a schematic of a half-bridge circuit 102 including switch paths 121a-123a according to a first embodiment. Additionally, the half-bridge circuit 102 includes the high-side capacitor C_{BHS}, high-side driver 132, high-side device 206, low-side capacitor C_{BLS}, low-side driver 133, and low-side device 208. The high-side device 206 and the low-side device 208 may operate as switches; and as illustrated, high-side device 206 and low-side device 208 may be realized with N-channel field effect transistors (FETs). Accordingly, high-side (HS) device 206 may also be referred to as high-side FET 206, and low-side (LS) device 208 may also be referred to as low-side FET 208.

The high-side driver 132 receives power (i.e., energy) from the high-side capacitor C_{BHS}, and can provide a gate signal GH (i.e., gate voltage GH) to the gate of the high-side FET 206. Additionally, the low-side driver 133 receives power (i.e., energy) from the low-side capacitor C_{BLS}, and can provide a gate signal GL (i.e., gate voltage GL) to the gate of the low-side FET 208. As described above the gate signals GL, GH can be voltages. Accordingly, the gate signal GH may also be referred to as gate voltage GH, and the gate signal GL may also be referred to as gate voltage GL.

Also illustrated is a resonant network 204 electrically coupled to the half-bridge circuit 102. The resonant network 204 includes the resonant capacitor C_{RES} and lumped impedance 205. According to an embodiment, a capacitance of the resonant capacitor C_{RES} may represent all capacitance of the resonant tank (e.g., resonant network 204), which may comprise parasitic capacitance and/or external capacitance. Additionally, a capacitance of the resonant capacitor C_{RES} may form a capacitive divider with high-side capacitor C_{BHS}; as discussed above, a capacitive divider may reduce the available bootstrap voltage V_{CHS}. According to the teachings herein, during power-up, the switch paths 121a-122a may be used to allow the high-side capacitor C_{BHS} to reach a sufficient (i.e., a sufficiently large) bootstrap voltage V_{CHS} to power the high-side driver 132.

Additionally, during power-up, the third switch path 123a may be used to control current I_{CLS} to the low-side capacitor C_{BLS}; and although the teachings are discussed with regards to a half-bridge circuit 102 driving a resonant network 204, other networks and configurations are possible. For instance, the resonant network 204 may be representative of any network receiving power (e.g., a current Ix) from a half-bridge circuit 102 and having an impedance with a series capacitive element similar to that of resonant capacitor C_{RES}.

The high-side driver 132 receives power (i.e., energy) from the high-side capacitor C_{BHS}, and can provide a gate signal GH (i.e., gate voltage GH) to the gate of the high-side FET 206. Additionally, the low-side driver 133 receives power (i.e., energy) from the low-side capacitor C_{BLS}, and can provide a gate signal GL (i.e., gate voltage GL) to the gate of the low-side FET 208. As described above the gate signals GL, GH can be voltages. Accordingly, the gate signal GH may also be referred to as gate voltage GH, and the gate signal GL may also be referred to as gate voltage GL.

The high-side FET 206 and the low-side FET 208 are electrically connected as a half-bridge to provide half-bridge voltage V_{X} from the half-bridge switch node NSW. As illustrated, the source of the high-side FET 206 and the drain of the low-side FET 208 are electrically connected together at the half-bridge switch node NSW.

In the steady state the half-bridge voltage V_{X} may be provided as a switching waveform (e.g., a square-wave switching waveform). The steady state switching waveform may transition between a maximum voltage provided by the source of the high-side FET 206 and a minimum voltage provided by the drain of the low-side FET 208.

As illustrated the half-bridge circuit 102 is electrically coupled to the resonant network 204 by virtue of the drain of the low-side FET 208 and the source of the high-side FET 206. The de input voltage VIN is provided to the drain of the high-side FET 206, and the source of the low-side FET 208 is electrically coupled to ground GND. During steady state the high-side FET 206 and the low-side FET 208 are switched to function as a half-bridge. Thus, for at least part of a steady state switching cycle, the high-side FET 206 may be on concurrent with the low-side FET 206 being off, alternatively, the low-side FET 206 may be off concurrent with the high-side FET 208 being on. Accordingly, the maximum voltage provided by the high-side FET 206 may be substantially equal to the input voltage VIN when the high-side FET 206 receives sufficient gate voltage GH (i.e., sufficient gate-to-source voltage); and the minimum voltage provided by the low-side FET 208 may be substantially equal to ground GND when the low-side FET 208 receives sufficient gate voltage GL (i.e., sufficient gate-to-source voltage).

During power-up and prior to reaching the steady state, the low-side capacitor C_{BLS} and the high-side capacitor C_{BHS} may not have sufficient charge (i.e., energy). Therefore, the low-side driver 133 may not receive sufficient power (i.e., sufficient holding voltage V_{CLS}) from the low-side capacitor C_{BLS} to provide a sufficient gate voltage GL; and the high-side driver 132 may not receive sufficient power (i.e., sufficient bootstrap voltage V_{CHS}) from the high-side capacitor C_{BHS} to provide sufficient gate voltage GH. According to the teachings herein, switch paths 121a-123a may be controlled to predictably charge the low-side capacitor C_{BLS} and the high-side capacitor C_{BHS} during power-up (i.e., during the power-up state).

Switch paths 121a-123a comprise the first switch path 121a, second switch path 122a, and third switch path 123a. First switch path 121a includes a diode D1, N-channel junction field effect transistor (JFET) Q1, and switch SW1 electrically coupled in series. Similarly, second switch path 122a includes a diode D2, N-channel junction field effect transistor (JFET) Q2, and switch SW2 electrically coupled in series; and third switch path 123a includes a diode D3, N-channel junction field effect transistor (JFET) Q3, and switch SW3 electrically coupled in series. In some embodiments diode D3 may be optionally excluded from the third switch path 123a.

As one of ordinary skill in the art may appreciate, the JFETs Q1-Q3 may be realized as integrated and/or discrete JFETs Q1-Q3. In other embodiments, the JFETs Q1-Q3 may be realized with tap elements as disclosed by U.S. Pat. No. 6,865,093 B2 to Donald R. Disney. In this regard the switch paths 121a-123a may also referred to as tap paths 121a-123a; and the currents I₁-I₃ may also be referred to as tap currents I₁-I₃.

First switch path 121a may be configured to block and conduct current I₁ in response to control signal V_{C1}. For instance, switch SW1 may be opened and closed by control signal V_{C1}, whereby switch SW1 conducts current I₁ when closed, and blocks current I₁ when opened. First switch path 121a may also block and conduct current by virtue of diode D1. As illustrated, diode D1 may block current In under reverse bias conditions and conduct current In under forward bias conditions. In this manner current I₁ may flow when diode D1 is forward biased and may be blocked when diode D1 is reverse biased. In one embodiment, diode D1 may advantageously block a reverse substrate current.

Similarly, second switch path 122a may be configured to block and conduct current I₂ in response to control signal V_{C2}; and third switch path 123a may be configured to block and conduct current I₃ in response to control signal V_{C3}. For instance, switch SW2 may, in response to control signal V_{C2}, conduct current I₂ when closed and block current I₂ when opened; and switch SW3 may, in response to control signal V_{C3}, conduct current I₃ when closed and block current I₃ when opened. Additionally, diode D2 may block current I₂ under reverse bias conditions and conduct current I₂ under forward bias conditions; and in one embodiment diode D2 may advantageously block reverse substrate current. Diode D3 may block current I₃ under reverse bias conditions and conduct current I₃ under forward bias conditions. As indicated above, diode D3 may be optionally excluded from the third switch path 123a. For instance, in some embodiments the current I₃ may be dc current to ground thereby obviating the need for diode D3.

Additionally, first switch path 121a may be configured to limit current I₁. For instance, JFET Q1 may limit a maximum value of current Ii by virtue of its operating point (e.g., gate to source voltage and drain to source voltage). As illustrated, the gate of JFET Q1 may be electrically coupled to ground GND (i.e., biased to ground potential). According to semiconductor device physics, JFET Q1 may limit current In to have a substantially constant value when the operating point (e.g., drain-to-source voltage and gate-to-source voltage) causes the JFET Q1 to enter saturation (i.e., to enter its current saturation region).

Similarly, second switch path 122a may be configured to limit current I₂. For instance, JFET Q2 may limit a maximum value of current I₂ by virtue of its operating point. As illustrated, the gate of JFET Q2 may be biased at a half-bridge potential Vx. According to semiconductor device physics, JFET Q2 may limit current I₂ to have a substantially constant value when the operating point (e.g., drain-to-source voltage and gate-to-source voltage) causes the JFET Q2 to enter its current saturation region.

Also, third switch path 123a may be configured to limit current I₃. For instance, JFET Q3 may limit a maximum value of current I₃ by virtue of its operating point. As illustrated, the gate of JFET Q3 may be electrically coupled to ground GND (i.e., biased to ground potential). According to semiconductor device physics, JFET Q3 may limit current I₃ to have a substantially constant value when the operating point (e.g., drain-to-source voltage and gate-to-source voltage) causes the JFET Q3 to enter its current saturation region.

Additionally, third switch path 123a may be configured to limit current I₃ as a function of low-side holding voltage V_{CLS}. For instance, as discussed below with respect to FIG. 5, current I₃ may be controlled to be a staircase and/or step function of the holding voltage V_{CLS}. In this manner, current I_{CLS}, which varies in proportion to current I₃, also becomes limited as a function of holding voltage V_{CLS}.

As discussed above, during power-up, prior to the steady state, the low-side capacitor C_{BLS} may initially not charge to adequate low-side holding voltage V_{CLS}; and the high-side capacitor C_{BHS} (i.e., bootstrap capacitor C_{BHS}) may not receive adequate bootstrap voltage V_{CHS}. In turn, the low-side driver 133 may not receive sufficient power (i.e., holding voltage V_{CLS}) and the high-side driver 132 may not receive sufficient power (i.e., bootstrap voltage V_{CHS}); therefore, the high-side FET 206 and the low-side FET 208 may not receive adequate gate voltages GL, GH to be switched on and off during power-up.

As illustrated, the first switch path 121a may be electrically coupled to the drain of the low-side FET 208 to provide a parallel (i.e., shunt) circuit path to ground GND. During power-up (i.e., a power-up state), control signal V_{C1} may be applied to the first switch path 121a to sink (i.e., shunt) current I₁ and to allow the half-bridge voltage V_{X} to be pulled down. For instance, when the control signal V_{C1} causes switch SW1 to close (i.e., to turn on), the half-bridge voltage V_{X} may be pulled down to a voltage determined, at least in part, by an operating condition of the diode D1 and the JFET Q1.

The second switch path 122a, may be electrically coupled between the drain of the high-side FET 206 and the high-side capacitor C_{BHS}. During power-up, control signal V_{C2} may be applied to the second switch path 122a to provide (i.e., to source) current I₂ to the high-side capacitor C_{BHS}. For instance, when the control signal V_{C2} causes switch SW2 to close (i.e., to turn on), current I_{CHS} may be provided to the high-side capacitor C_{BHS}. According to basic circuit theory, the current I_{CHS} may be a component of the current I₂ sourced by the second switch path 122a.

The control signal V_{C1} may be provided concurrent with control signal V_{C2} SO that the first switch path 121a sinks current I₁ (i.e., demands current I₁); while the second switch path 122a provides current I₂ (i.e., avails current I₂). The amount of current ICHS available to charge the high-side capacitor C_{BHS}, may depend, at least in part, upon the operating condition of the diode D2 and the JFET Q2. For instance, according to semiconductor device physics, the amount of current I₂ availed by the second switch path 122a may depend, at least in part, upon a saturation current of the JFET Q2.

Additionally, the operating conditions of the first switch path 121a and the second switch path 122a may be tailored so that the capacitor C_{RES} does not interfere with the charging of the high-side capacitor C_{BHS}. For instance, JFET Q1 and JFET Q2 may be designed to operate with characteristic curves such that first switch path 121a demands more current Il than can be supplied by the second switch path 122a. Under these conditions, the first circuit path 121a may pull the half-bridge voltage V_{X} down; this in turn may reduce (i.e., divert away) the current I_{X} availed to the resonant capacitor C_{RES}. In this way, the resonant capacitor C_{RES} is shunted by the first switch path 121a so that the resonant capacitor voltage VC_{RES} is substantially reduced. Consequently, the current I_{CHS} may charge the high-side capacitor C_{BHS} to a sufficient bootstrap voltage V_{CHS} without substantially charging the resonant capacitor C_{RES}. As discussed herein, the control signals V_{C1} and V_{C2} may be provided to regulate and/or limit the bootstrap voltage V_{CHS} to a maximum (e.g., twelve volts).

Additionally, the third switch path 123a, may be electrically coupled between the drain of the high-side FET 206 and the low-side capacitor C_{BLS}. During power-up, control signal V_{C3} may be applied to the third switch path 123a to provide (i.e., to source) current I₃ to the low-side capacitor C_{BLS}. According to basic circuit theory, the current ICLS may be a component of the current I₃ sourced by the third switch path 123a.

The control signal V_{C3} may be provided so that the third switch path 123a sources and limits the current I₃ to protect the low-side capacitor C_{BLS}. The current ICLS, provided to the low-side capacitor C_{BLS}, may depend at least in part, upon the operating condition of diode D3 and the JFET Q3. For instance, the amount of current may be limited by virtue of the operating conditions (e.g., characteristic curve) of JFET Q3. As discussed herein, the control signal V_{C3} may be provided to regulate and/or limit the low-side holding voltage V_{CLS} to a maximum (e.g., twelve volts).

Additionally, as described herein, the current I₃ may be a function of the low-side holding voltage V_{CLS}. As discussed below with regards to FIG. 5, current I₃, and consequently current I_{CLS}, may be controlled as a function of holding voltage V_{CLS}. In this way, components of third switch path 123a (e.g., JFET Q3), may be protected from short-circuit of holding voltage V_{CLS} and/or thermal stress.

FIG. 2B is a schematic of a half-bridge circuit 102 including switch paths 121b-123b according to a second embodiment. Half-bridge circuit 102 of FIG. 2B is similar to that of FIG. 2A, except the switch paths 121a-123a are replaced by switch paths 121b-123b . Switch paths 121b-123b comprise first switch path 121b, second switch path 122b, and third switch path 123b.

Similar to switch paths 121a-123a, switch paths 121b-123b may be used during power-up. Like switch paths 121a-122a, switch paths 121b-122b may be configured to assure high-side capacitor C_{BHS} charges to an adequate bootstrap voltage V_{CHS} by current ICHS; and like third switch path 123a, third switch path 123b may be configured to limit the current I_{CLS} and to prevent inrush to low-side holding capacitor C_{BLS}.

In contrast to switch paths 121a-123a, switch paths 121b-123b include N-channel field effect transistors (NFETs) M1-M3 instead of JFETs Q1-Q3 and switches SW1-SW3. As illustrated, first switch path 121b comprises diode D1 electrically coupled in series with NFET M1; the cathode of diode D1 may be electrically coupled to the drain of NFET M1. Second switch path 122b comprises diode D2 electrically coupled in series with NFET M2; the cathode of diode D2 may be electrically coupled to the drain of NFET M2. Third switch path 123b comprises diode D3 electrically coupled in series with NFET M3; the cathode of diode D3 may be electrically coupled to the drain of NFET M3.

Switch paths 121b-123b may provide similar electrical function as switch paths 121a-123a by virtue of the control signals V_{C1}-V_{C3}.

With regards to switch paths 121a-123a, the control signals V_{C1}-V_{C3} may be provided to their respective switches SW1-SW3 to control switches SW1-SW3 to individually operate in the on-state or off-state. As discussed above, in switch paths 121a-123a, currents I₁-I₃ may be tailored (i.e., limited) by virtue of the operating conditions of JFETs Q1-Q3; as discussed above, the currents I₁-I₃ may be limited according to saturation characteristics and device operating points (e.g., applied gate-to-source voltage and/or applied drain-to-source voltage) of JFETs Q1-Q3.

With regards to switch paths 121b-123b , the control signals V_{C1}-V_{C3} may be provided to (i.e., may drive) the gates of NFETs M1-M3. In this way the behavior of currents I₁-I₃ in switch paths 121b-123b may be similar to the behavior currents I₁-I₃ in switch paths 121a-123a.

For instance, control signal V_{C1} may be provided to the gate of NFET MI to turn NFET M1 off by forcing the gate-to-source voltage of NFET MI to be less than a threshold voltage; alternatively, and additionally, control signal V_{C1} may be provided to the gate of NFET M1 to force NFET M1 to operate in its saturation region based on a function of the magnitude of control signal V_{C1}. In this way the electrical behavior of first switch path 121b may be tailored to have similar electrical behavior (i.e., similar demand for current I₁) as first switch path 121a. Similarly, control signal V_{C2} may be provided to the gate of NFET M2 so that second switch path 122b is tailored to have similar electrical behavior (i.e., similar supply of current I₂) as second switch path 122a; and control signal V_{C3} may be provided to the gate of NFET M3 so that third switch path 123b is tailored to have similar electrical behavior (i.e., similar supply of current I₃) as third switch path 123a.

FIG. 2C is a schematic of a half-bridge circuit 102 including switch paths 121c-123c according to a third embodiment. Half-bridge circuit 102 of FIG. 2C is similar to that of FIG. 2B, except the switch paths 121b-123b are replaced by switch paths 121c-123c. Switch paths 121c-123c comprise first switch path 121c, second switch path 122c, and third switch path 123c.

Similar to switch paths 121a-123a and to switch paths 121b-123b , switch paths 121c-123c may be used during power-up. Like switch paths 121a-122a and switch paths 121b-122b , switch paths 121c-122c may be configured to assure high-side capacitor C_{BHS} charges to an adequate bootstrap voltage V_{CHS} by current I_{CHS}; and like third switch path 123a and third switch path 123b, third switch path 123c may be configured to limit the current I_{CLS} to reduce inrush to low-side holding capacitor C_{BLS}.

In contrast to switch paths 121b-123b , switch paths 121c-123c further include resistors R1-R3. As illustrated, first switch path 121c comprises diode D1 electrically coupled in series with NFET M1 and with resistor R1. Second switch path 122c comprises diode D2 electrically coupled in series with NFET M2 and with resistor R2; and third switch path 123c comprises diode D3 electrically coupled in series with NFET M3 and with resistor R3.

Resistors R1-R3 may advantageously provide an additional level and/or degree of freedom for current limit in switch paths 121c-123c. Additionally, using resistors R1-R3 to respectively limit currents I₁-I₃, may mitigate variability in process and/or operating conditions. For instance, in some embodiments there may be large variation (e.g., process variation) in the saturation characteristics of an NFET (e.g., NFET M1, NFET M2, and/or NFET M3) while there may be small variation in a resistance (e.g., sheet resistance) of a resistor (e.g., resistor R1, resistor R2, and/or resistor R3).

FIG. 2D is a schematic of a half-bridge circuit 102 including switch paths 121d-123d according to a third embodiment. Half-bridge circuit 102 of FIG. 2D is similar to that of FIG. 2A, except the switch paths 121a-123a are replaced by switch paths 121d-123d. Switch paths 121d-123d comprise first switch path 121d, second switch path 122d, and third switch path 123d.

Similar to switch paths 121a-123a, switch paths 121b-123b , and switch paths 121c-123c, switch paths 121d-123d may be used during power-up. Switch paths 121d-122d may similarly be configured to assure high-side capacitor C_{BHS} charges to an adequate bootstrap voltage V_{CHS} by current I_{CHS}; and third switch path 123d may be configured to control current I_{CLS}.

In contrast to switch paths 121a-122a, switch paths 121d-122d further include resistors R11-R12. As illustrated, first switch path 121d comprises diode D1 electrically coupled in series with JFET Q1, with switch SW1, and with resistor R11; and second switch path 122d comprises diode D2 electrically coupled in series with JFET Q2, with switch SW2, and with resistor R12. The resistance of resistor R11 and the resistance of resistor R12 may be selected to assure that first switch path 121d demands more current I₁ than may be provided by second switch path 122d. For instance, in an embodiment, the resistance of resistor R12 may be greater than the resistance of resistor R11.

In contrast to third switch path 123a, third switch path 123d includes a current select element 222. As illustrated, first switch path 123d comprises diode D3 electrically coupled in series with JFET Q3, with switch SW3, and with control select element 222; also current select element 222 may receive control signal V_{C3}. In addition to controlling switch SW3 to conduct or block current I₃, control signal V_{C3} may also vary the amount (e.g., amplitude) of current I₃. For instance, in one application current select element 222 may be a voltage controlled current source limiting current I₃ in proportion to control signal V_{C3}. Alternatively, and additionally, current select element 222 may comprise voltage controlled resistance limiting the current I₃ as a function of the control signal V_{C3}. Additionally, current select element 222 may include a switched resistor network availing discrete resistance values as a function of the control signal V_{C3}.

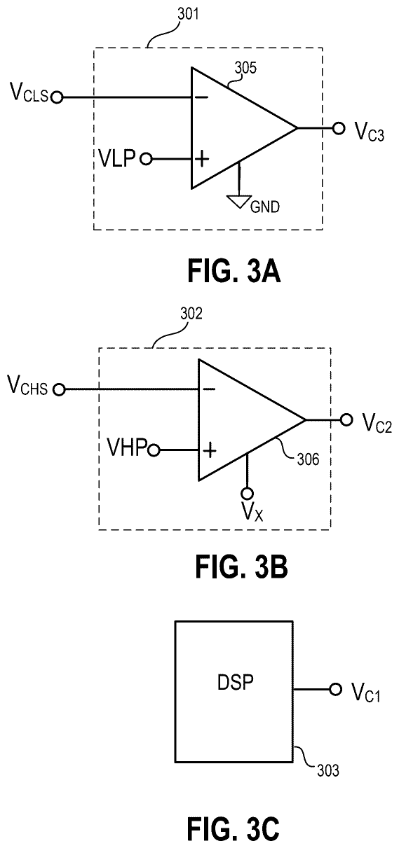

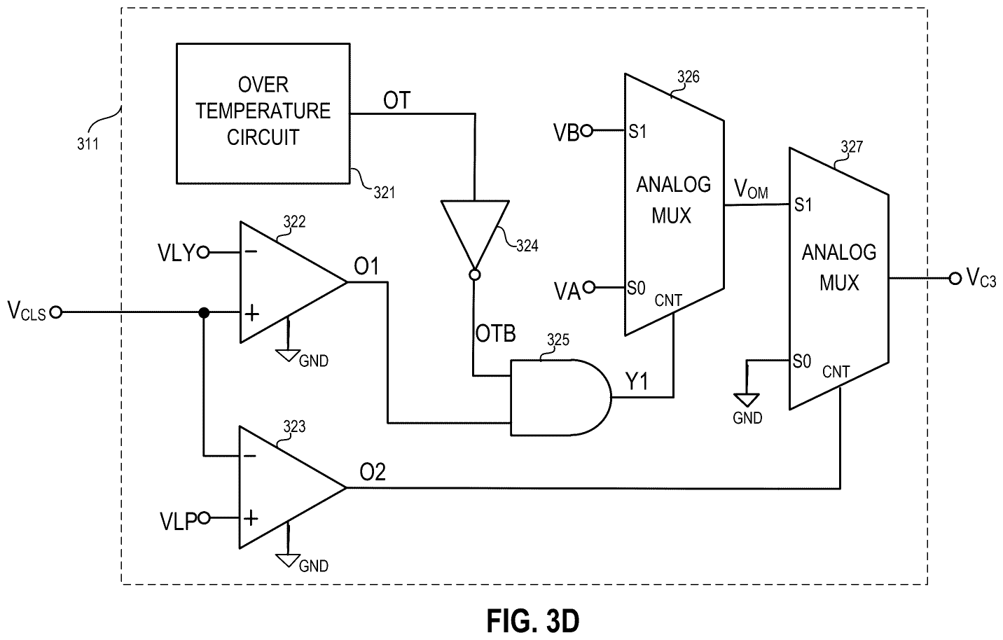

FIG. 3A illustrates a control circuit 301 according to an embodiment. As illustrated, control circuit 301 includes a comparator 305. Comparator 305 may be referenced to ground GND and may receive the low-side holding voltage V_{CLS} at its inverting input and a peak value VLP (e.g., a reference voltage VLP) at its noninverting input.

As illustrated, control circuit 301 may provide control signal V_{C3} (i.e., the output of comparator 305) based on a comparison of the low-side holding voltage V_{CLS} to the peak value VLP. For instance, when the low-side holding voltage V_{CLS} is less than peak value VLP, control circuit 301 may exert control signal V_{C3} to turn switch SW3 on and/or to drive the gate of NFET M3 high. Alternatively, when the low-side holding voltage V_{CLS} is greater than the peak value VLP, the control circuit 301 may exert control signal V_{C3} to turn switch SW3 off and/or to drive the gate of NFET M3 low.

In this manner, the control signal V_{C3} may regulate the low-side holding voltage V_{CLS}. In one embodiment the low-side holding voltage V_{CLS} may be regulated to a voltage between ten and twenty volts; and as one of ordinary skill in the art may appreciate, other configurations are possible. For instance, a scaled value of the low-side holding voltage V_{CLS} may instead be compared with a peak value VLP.

FIG. 3B illustrates a control circuit 302 according to an embodiment. As illustrated, control circuit 302 includes comparator 306. Comparator 306 may be referenced to the half-bridge voltage Vx, instead of being referenced to ground GND. Comparator 306 may receive the bootstrap voltage V_{CHS} at its inverting input and a peak value VHP at its noninverting input.

As illustrated, control circuit 302 may provide control signal V_{C2} (i.e., the output of comparator 306) based on a comparison of the bootstrap voltage V_{CHS} to the peak value VHP. For instance, when the bootstrap voltage V_{CHS} is less than peak value VHP, control circuit 302 may exert control signal V_{C2} to turn switch SW2 on and/or to drive the gate of NFET M2 high. Alternatively, when the bootstrap voltage V_{CHS} is greater than the peak value VHP, the control circuit 302 may exert control signal V_{C2} to turn switch SW2 off and/or to drive the gate of NFET M2 low.

In this manner, the control signal V_{C2} may regulate the bootstrap voltage V_{CHS}. In one embodiment the bootstrap voltage V_{CHS} may be regulated to a voltage between ten and twenty volts; and as one of ordinary skill in the art may appreciate, other configurations are possible. For instance, a scaled value of the bootstrap voltage V_{CHS} may instead be compared with the peak value VHP.

FIG. 3C illustrates a control circuit 303 according to an embodiment. As illustrated, control circuit 303 may be a digital signal processor (DSP) control circuit 303 which provides control signal V_{C1} as a function of system and/or state variables. For instance, control signal V_{C1} may drive the gate of NFET M3 high, based upon an operating state (e.g., voltages and/or currents) of half-bridge circuit 102.

As presented in the above description, control circuits 301-303 are non-limiting embodiments presented for illustrative purposes. As one of ordinary skill in the art may appreciate, other configurations may be possible. For instance, as discussed below with regards to control circuit 311, one or more of control circuits 301-303 may provide control signals V_{C1}-V_{C3} as a function of temperature (e.g., junction temperature). Additionally, one of more of the control signals V_{C1}-V_{C3} may be provided with variable amplitude.

FIG. 3D illustrates control circuit 311 for providing control signal V_{C3} according to another embodiment. Control circuit 311 includes an over-temperature circuit 321, a comparator 322, a comparator 323, an inverter 324, an AND gate 325, an analog multiplexer 326, and analog multiplexer 327.

Over-temperature circuit 321 may provide a logic signal OT (e.g., a logic voltage OT) as a function of temperature (e.g., a device junction temperature). For instance, when temperature exceeds a threshold temperature (e.g., eighty-five degrees Centigrade) then logic signal OT may transition to a logic high value. As one of ordinary skill in the art may appreciate, there may be many ways to realize an over-temperature circuit 321 for determining when temperature has exceeded a threshold temperature.

As illustrated, comparator 322 may be referenced to ground GND and may receive the low-side holding voltage V_{CLS} at its noninverting input and a threshold value VLY at its inverting input. As illustrated, comparator 322 may provide logic signal O1 in response to the low-side holding voltage V_{CLS}. As configured, logic signal O1 may transition high (i.e., from logic low to logic high) when the low-side holding voltage V_{CLS} exceeds the threshold value VLY.

Comparator 323 may be referenced to ground GND and may receive the low-side holding voltage V_{CLS} at its inverting input and a peak value VLP at its noninverting input. Comparator 322 may also provide logic signal O2 in response to the low-side holding voltage V_{CLS}. As configured, logic signal O2 may transition low (i.e., from logic high to logic low) when the low-side holding voltage V_{CLS} exceeds the peak value VLP.

Also as illustrated, inverter 324 inverts logic signal OT to provide logic signal OTB (i.e., the logical NOT of logic signal OT). Additionally, AND gate 325 performs a logical AND of logic signal OTB and of logic signal O1 to provide logic signal Y1.

Analog multiplexer 326 receives logic signal Y1 at its control input CNT and analog signals VA, VB at its low-select and high-select inputs S0, S1, respectively. As one of ordinary skill in the art may appreciate, analog multiplexer 326 may function as an analog switch to provide analog signal V_{OM} in response to logic signal Y1. As illustrated, analog multiplexer 326 may switch analog signal V_{OM} to equal (i.e., to substantially equal) analog signal VA, when logic signal Y1 is low (i.e., a logic low). Conversely, analog multiplexer 326 may switch analog signal Vom to equal (i.e., to substantially equal) analog signal VB, when logic signal Y1 is high (i.e., a logic high).

Analog multiplexer 327 receives logic signal O2 at its control input CNT.

Additionally, analog multiplexer 327 receives ground GND and analog signal V_{OM} at its low-select and high-select inputs S0, S1, respectively. As one of ordinary skill in the art may appreciate, analog multiplexer 327 may function as an analog switch to provide control signal V_{C3} in response to logic signal O2. As illustrated, analog multiplexer 327 may switch (i.e., may provide) control signal V_{C3} to equal (i.e., to substantially equal) ground GND (i.e., logic low) when logic signal O2 is high. Conversely, analog multiplexer 327 may switch control signal V_{C3} to equal (i.e., to substantially equal) analog signal V_{OM} when logic signal O2 is low (i.e., a logic low).

With reference to switch path 123d, control circuit 311 may provide control signal V_{C3} to avail voltage regulation and current limit. For instance, by virtue of comparator 323 and analog multiplexer 327, logic signal O2 may switch control signal V_{C3} to ground (i.e., low) when low-side holding voltage V_{CLS} exceeds the peak value VLP. Additionally, by virtue of analog multiplexers 326-327, logic signal O2 may switch control signal V_{C3} to equal analog signal V_{OM} when low-side holding voltage V_{CLS} is less than the peak value VLP.

Also with reference to switch path 123d, control circuit 311 may avail current limit as a function of temperature. Additionally, current I₃ may be limited to a relatively low initial value (e.g., two milliamperes) until the low-side holding voltage V_{CLS} reaches the threshold value VLY (e.g., seven volts). In one embodiment, reaching the threshold value VLY may indicate a safe operating condition absent of fault (e.g., a short-circuit fault). After the threshold value is exceeded, the current I₃ may be further increased to a larger value (e.g., ten milliamperes) availing increased current to the low-side driver 133 and to the low-side capacitor C_{BLS}.

According to embodiments of the teachings herein, the switch paths (i.e., switch paths 121-123, switch paths 121a-123a, switch paths 121b-123b , switch paths 121c-123c, and/or switch paths 121d-123d) may be functional during power-up (i.e., the power-up state); and upon reaching steady state (i.e., steady state switching conditions), the switch paths (e.g., switch paths 121-123) may be open circuit. For instance, upon reaching the steady state, the control circuits 301-303 may be configured to disable (i.e., to open circuit) switch paths (i.e., switch paths 121-123, switch paths 121a-123a, switch paths 121b-123b , switch paths 121c-123c, and/or switch paths 121d-123d). Thus, in the steady state, the control signals V_{C1}-V_{C3} may be provided to turn off switches SW1-SW3 and/or to drive the gates of NFETs M1-M3 low. In the steady state, the high-side FET 206 and the low-side FET 208 may switch according to a steady state switching frequency; and conventional circuitry may be implemented (i.e., enabled) for recycling the bootstrap voltage V_{CHS}, and/or for providing the low-side holding voltage V_{CLS}.

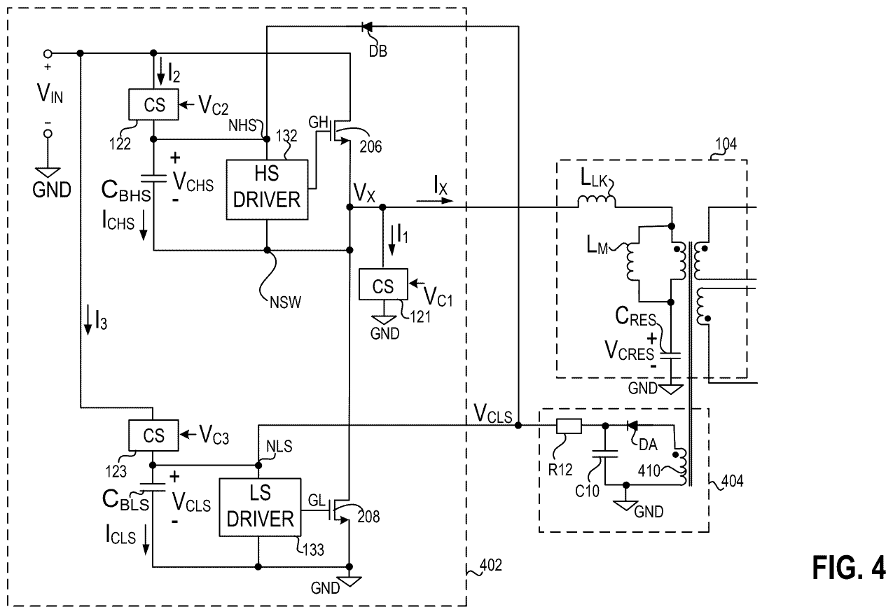

For instance, FIG. 4 illustrates a schematic of the half-bridge circuit 402 according to another embodiment. Half-bridge circuit 402 is similar to half-bridge circuit 102 except it includes a bootstrap diode DB. An anode of the bootstrap diode DB is electrically coupled to the low-side node NLS; and a cathode of the bootstrap diode DB is electrically coupled to the high-side node NHS. As discussed above, during steady state switching conditions (i.e., during steady state), switch paths 121-122 may be open circuit. Also, in the steady state, the bootstrap diode DB may recycle the bootstrap voltage V_{CHS} in accordance with a switching waveform (e.g., a square wave) of the half-bridge voltage V_{X} at the half-bridge switch node NSW.

Also illustrated by the schematic of the half-bridge circuit 402 is the resonant network 104 and an auxiliary supply 404. Auxiliary supply 404 includes a rectifier diode DA, an auxiliary winding 410, a decoupling capacitor C10, and a decoupling resistor R12. The auxiliary winding 410 is electrically connected between ground GND and an anode of the rectifier diode DA. A first terminal of the decoupling capacitor C10 is electrically connected to the cathode of the rectifier diode DA; and a second terminal of the decoupling capacitor C10 is electrically connected to ground GND. The decoupling resistor R12 is connected between the cathode of the rectifier diode DA and the low-side node NLS to provide low-side holding voltage V_{CLS}.

As discussed above, during steady state switching conditions (i.e., during steady state), switch path 123 may be open circuit. Also, in the steady state, the auxiliary supply 404 may provide low-side holding voltage V_{CLS} (i.e., a dc rectified voltage V_{CLS}) to the low-side holding capacitor C_{BLS}.

FIG. 5 illustrates waveforms 501-509 according to an embodiment. With reference to FIG. 4, waveform 501 may correspond with half-bridge voltage V_{X}. Waveform 502 may correspond with bootstrap voltage V_{CHS}. Waveforms 503 and 504 may correspond with currents I₁ and I₂, respectively. Waveforms 505 and 506 may correspond with control signals V_{C1} and V_{C2}, respectively. Waveform 507 may correspond with low-side holding voltage V_{CLS}. Waveform 508 may correspond with current I₃; and waveform 509 may correspond with control signal V_{C3}.

Waveforms 501-509 are presented as a function of time. As illustrated, at time t0 power-up is initiated; and half-bridge circuit 402, resonant network 104, and auxiliary supply 404 may operate in a transient state (i.e., in a power-up state) between times t0 and tss. Following time tss, the half-bridge circuit 402, resonant network 104, and auxiliary supply 404 may transition to the steady state (i.e., operate in the steady state).

Additionally, and in accordance with the teachings herein, waveforms 505 and 506 may illustrate a method and/or sequence of providing control signals V_{C1} and V_{C2} to switch paths 121 and 122, respectively. For instance, control signal V_{C1} may be provided by control circuit 303 based, at least in part, on state conditions including, but not limited to, a value of low-side holding voltage V_{CLS} and/or a value of the bootstrap voltage V_{CHS}. Control signal V_{C2} may be provided by control circuit 302; and as discussed above with regards to FIG. 3, control signal V_{C2} may be provided relative to (i.e., referenced to) the half-bridge voltage V_{X}.

Between times t0 and t1 there may exist a circuit path including second switch path 122, high-side capacitor C_{BHS}, and resonant network 104. As illustrated by waveform 506, between times t0 and t1 control signal V_{C2} may ramp (i.e., increase) to value V2M (e.g., five volts relative to the half-bridge voltage Vx). In response, second switch path 122 may conduct current I₂ by virtue of a switch (e.g., switch SW2) and/or NFET (e.g., NFET M2). For instance, as illustrated by waveform 504, between times t0 and t1 current I₂ increases to value I2M (e.g., two milliamperes).

Additionally, as illustrated by waveform 505, control signal V_{C1} may be exerted low (e.g., ground and/or zero volts) by control circuit 303. Thus, first switch path 121 may block current In by virtue of switch SW1 and/or NFET M1; and as illustrated by waveform 503, current I1 remains low (i.e., substantially equal to zero). Because first switch path 121 blocks current I₁, current I₂ may be provided to the resonant network 104 and may contribute to current I_{X}.

Accordingly, between times t0 and t1, half-bridge voltage V_{X} may increase by virtue of a capacitive voltage divider formed by the high-side capacitor C_{BHS} with the resonant capacitor C_{RES}, thus, waveform 501 (i.e., the half-bridge voltage V_{X}) may increase toward a value VXY. Concurrently, the bootstrap voltage V_{CHS} may also increase by virtue of the capacitive voltage divider of the high-side capacitor C_{BHS} with the resonant capacitor C_{RES}; and as illustrated by waveform 502, the bootstrap voltage V_{CHS} may approach value VHY (e.g., seven volts).

Also, as illustrated by waveform 504, as half-bridge voltage V_{X} approaches value VXY, current I₂ may decay in accordance with any impedance presented by the circuit path including second switch path 122, high-side capacitor C_{BHS}, and resonant network 104.

Value VXY may be determined, at least in part, by the input voltage V_{IN} and by the bootstrap voltage V_{CHS}. For instance, according to circuit theory, value VXY may be substantially equal to the value of the input voltage V_{IN} less the value of the bootstrap voltage V_{CHS}, and less any support voltage across second switch path 122. As discussed above, value VHY (e.g., seven volts) may be too low for steady state operation; and according to the teachings herein, switch paths 121 and 122 may be used to augment the bootstrap voltage V_{CHS}.

As illustrated by waveforms 501-506, between times t1 and t2 control signal V_{C1} may continue to be exerted low; and control signal V_{C2} may continue to be exerted high (i.e., to value V2M). Accordingly, the bootstrap voltage V_{CHS} may continue to be limited to value VHY while the half-bridge voltage V_{X} sustains value VXY. Also current I₂ may continue decaying towards zero (i.e., zero milliamperes) concurrent with current I₁ remaining at zero (i.e., zero milliamperes).

According to the teachings herein, at time t2 control signal V_{C1} may be exerted high so that the first switch path 121 demands more current I₁ than may be provided by second switch path 122. For instance, at time t2 control circuit 303 may exert control signal V_{C1} to value V1M (e.g., five volts) based on state conditions including, but not limited to, a value of the bootstrap voltage V_{CHS} (e.g., value VHY) and/or a value of the half-bridge voltage V_{X} (e.g., value VXY). Thus, as illustrated by waveform 501, at time t2 the first switch path 121 may pull the half-bridge voltage V_{X} to a low voltage (e.g., zero volts).

As illustrated by waveforms 505 and 506, between times t2 and t3 control signal V_{C1} may be exerted high to value V1M, and control signal V_{C2} may be exerted high to value V2M. According to the teachings herein, the first switch path 121 may be configured to demand (i.e., sink) a larger current I₁ than can be supplied (i.e., sourced) by the second switch path 122.

As illustrated by waveform 502, the bootstrap voltage V_{CHS} may increase to a peak value VHP (e.g., twelve volts) at time t3. In response, the control voltage V_{C2} (i.e., waveform 506) may be exerted low by control circuit 302. From time t3 to time t6, the control signal V_{C1} is exerted high; and the first switch path 121 and the second switch path 122 may maintain (i.e., regulate) the bootstrap voltage V_{CHS} to peak value VHP by virtue of control circuit 302. For instance, as illustrated by waveforms 502-506, from times t3 through t6 the bootstrap voltage V_{CHS} may be limited to peak value VHP in response to control circuit 302 changing states at times t4 and t5.

At time t6 control circuit 303 may exert control signal V_{C1} low based on state conditions. For instance, control signal V_{C1} may be exerted low at time t6 in response to the bootstrap voltage V_{CHS} and/or the low-side holding voltage V_{CLS} having reached adequate voltage levels. Additionally, upon reaching the steady state, control circuit 303 may continue to exert control signal V_{C1} low in accordance with the teachings herein.

At time t7 the low-side driver 133 and high-side driver 132 may have adequate voltage for providing (i.e., driving) gate signals GL and GH. Accordingly, at time t7 the half-bridge voltage V_{X} (i.e., waveform 501) begins switching to a higher value VXM. It may be appreciated that in the steady state, the value VXM may depend, at least in part, upon a steady state value of the low-side holding voltage V_{CLS}. Additionally, the value VXM may be greater than the value VXY. For instance, the value VXY may be seventy-five percent that of the value VXM.

Also in accordance with the teachings herein, waveform 509 may illustrate a method and/or sequence of providing control signal V_{C3} to third switch path 123 (e.g., third switch path 123d). Control signal V_{C3} may be provided by control circuit 301 and/or control circuit 311; additionally, the third switch path 123 (e.g., switch path 123d) may be configured to provide current I₃ as function of the low-side holding voltage V_{CLS} (i.e., waveform 507). As discussed above, providing current I₃, and consequently current I_{CLS}, as a function of holding voltage V_{CLS} may advantageously afford short circuit protection and/or thermal overload protection to components of the third switch path 123.

Between times t0 and t11 control signal V_{C3} (i.e., waveform 509) increases to value V3Y (e.g., two volts); and low-side holding voltage V_{CLS} (i.e., waveform 507) increases to threshold value VLY (e.g., seven volts). Between times t11 and t12 control signal V_{C3} may, in response to the low-side holding voltage V_{CLS} reaching threshold value VLY, transition to value V3M (e.g., five volts). Also, between times t11 and t12, low-side holding voltage V_{CLS} may increase from threshold value VLY (e.g., seven volts) to peak value VLP (e.g., twelve volts).

According to the teachings herein, switch path 123 may provide current I₃ (i.e. waveform 508) as a function of the low-side holding voltage V_{CLS}. For instance, between times t0 and t11, while holding voltage V_{CLS} is less than threshold value VLY, current I₃ may be limited to value 13Y (e.g., two milliamperes). For times greater than time t11, while holding voltage V_{CLS} is greater than threshold value VLY and less than peak value VLP, current I₃ may be limited to value I3M (e.g., ten milliamperes). Thus, current 13 follows a staircase function of voltage V_{CLS}.

At time t12, in response to the holding voltage V_{CLS} reaching its peak value VLP, control signal V_{C3} may be exerted low by control circuit 301 and/or control circuit 311. From times t12 to time tss, the third switch path 123 may maintain (i.e., regulate) the low-side holding voltage V_{CLS} to peak value VLP. For instance, as illustrated by waveforms 507-509, from times t12 through tss, the low-side holding voltage V_{CLS} may be limited to peak value VLP in response to comparator 303 changing states at times t12-t16.

Following time tss, the half-bridge voltage V_{X} continues switching in the steady state; and according to the teachings herein, switch paths 121-123 may be configured to block currents I₁-I₃ (i.e., to be open circuit). In the steady state, auxiliary supply 404 may provide the low-side holding voltage V_{CLS}; and according to the switching cycle of waveform 501, the bootstrap diode DB may recycle the bootstrap voltage V_{CHS}.

For instance, as illustrated by waveform 507, at time tss the auxiliary supply 404 may provide the low-side holding voltage V_{CLS} to reach a steady-state value VL_{M} (e.g., eighteen volts). Because the steady-state value VL_{M} is greater than the peak value VLP (i.e., the value limited by control circuit 301 and/or control circuit 311), the control signal V_{C3} (i.e., waveform 509) is exerted low.

Similarly, bootstrap diode DB may recycle the bootstrap voltage V_{CHS} (i.e., waveform 502) to reach a steady-state value VHM (e.g., eighteen volts relative to half-bridge voltage V_{X}). Because the steady-state value VHM is greater than the peak value VHP (i.e., the value limited by control circuit 302), control signal V_{C2} (i.e., waveform 506) is also exerted low.

Although FIG. 5 shows waveforms 501-509 according to an embodiment of a half-bridge circuit (e.g., half-bridge circuit 402), other configurations and waveforms are possible. For instance, in another embodiment the second switch path 122 may be further configured to provide current I₂ as a function of the bootstrap voltage VBHS. In this way, similar to third switch path 123, second switch path 122 may also avail thermal overload protection to its components (e.g., JFET Q2).

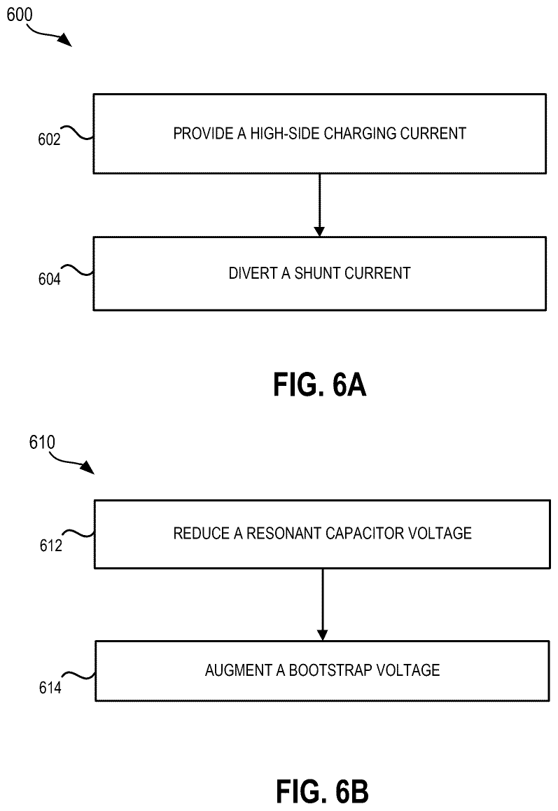

FIG. 6A illustrates a conceptual block diagram 600 for operating a resonant converter (e.g., LLC converter 100) during a power-up state according an embodiment. The conceptual block diagram 600 includes element 602 and element 604. Element 602 comprises the concept of providing high-side charging current (i.e., current I₂ and/or current ICHS); and element 604 comprises the concept of diverting a shunt current (i.e., current I₁).

As described herein, during power-up, a first switch path (e.g., any one of first switch paths 121, 121a-c) may be configured to demand (i.e., sink) a current I₁. Concurrently, a second switch path (e.g., any one of second switch paths 122, 122a-c) may be configured to supply (i.e., source) a current I₂. According to the teachings herein, when the demand for current I₁ exceeds the supply of current I₂, then a current I_{CHS} may adequately charge a bootstrap capacitor C_{BHS} to supply a high-side driver 132 with ample bootstrap voltage V_{CHS}.

FIG. 6B illustrates a conceptual block diagram 610 for operating a resonant converter (e.g., LLC converter 100) during a power-up state according to the embodiment of FIG. 6A. The conceptual block diagram 610 includes element 612 and element 614.

Element 612 may correspond with an additional result of conceptual block diagram 600: namely, a resonant capacitor voltage (i.e., voltage VC_{RES}) may be reduced in accordance with the teachings herein. Element 612 may further relate to a condition of conceptual block diagram 600: namely, the demand for current I₁ exceeds the supply of current I₂. According to the teachings herein, when the demand for current I₁ exceeds the supply of current I₂, resonant capacitor voltage VCREs may be reduced so that the capacitance of a resonant capacitor C_{RES} does not interfere with the charging of the bootstrap capacitor C_{BHS}.

Element 614 may also correspond with an additional result of conceptual block diagram 600: namely, the bootstrap voltage V_{CHS} may be augmented. According to the teachings herein, when the demand for current I₁ exceeds the supply of current I₂, a current I_{CHS} may adequately charge a bootstrap capacitor C_{BHS} to supply (i.e., to augment) a high-side driver 132 with ample bootstrap voltage V_{CHS}.

Although the conceptual block diagram 600 has been described with respect to a resonant converter (i.e., LLC converter 100), other switching converters are possible. For instance, as described above, the elements of conceptual block diagrams 600 and 610 may apply to other switching converters wherein a half-bridge circuit 102 is electrically coupled to a network having a capacitive element like that of resonant network 204. The teachings herein may, for instance, also apply to an LCC converter.

The above description of illustrated examples of the present disclosure, including what is described in the Abstract, are not intended to be exhaustive or to be limitation to the precise forms disclosed. While specific embodiments of, and examples for control of a power converter using switch paths during power-up are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings herein.

Although the present invention is defined in the claims, it should be understood that the present invention can alternatively be defined in accordance with the following examples.

Example 1: A half-bridge circuit (e.g., half-bridge circuit 102) is electrically coupled to a resonant network, the half-bridge circuit comprises: a high-side device, a low-side device, and a first switch path. The low-side device is electrically coupled to the high-side device. The first switch path is electrically coupled to the low-side device. For instance, the first switch path may be electrically coupled to the drain of the low-side device. During a power-up state (i.e., power-up), the first switch path is configured to divert a shunt current (e.g., current I₁) away from the resonant network.

Example 2: The half-bridge circuit of example 1, wherein the first switch path comprises a field effect transistor (e.g. JFET Q1 and/or NFET M1).

Example 3: The half-bridge circuit of example 2, wherein the field effect transistor is a junction field effect transistor (e.g., JFET Q1).

Example 4: The half-bridge circuit of any one of the preceding examples, wherein the first switch path comprises a diode (e.g., diode D1).

Example 5: The half-bridge circuit of any one of the preceding examples, wherein the first switch path comprises a switch (e.g., switch SW1).

Example 6: The half-bridge circuit of any one of the preceding examples, wherein during the power-up state the first switch path is configured to divert the shunt current so as to reduce a resonant capacitor voltage (e.g., voltage VC_{RES}).

Example 7: The half-bridge circuit of any one of the preceding examples, wherein during a steady state the first switch path is configured to be open circuit.

Example 8: The half-bridge circuit of any one of the preceding examples, further comprising: a high-side capacitor (i.e., bootstrap capacitor C_{BHS}) and a second switch path. The second switch path is configured to provide a high-side charging current (e.g., current I_{CHS}) to the high-side capacitor.

Example 9: The half-bridge circuit of any one of the preceding examples, wherein the high-side capacitor is configured to provide a high-side voltage (e.g., bootstrap voltage V_{CHS}), and wherein the first switch path is configured to divert the shunt current so as to augment the high-side voltage.

Example 10: The half-bridge circuit of any one of the preceding examples, wherein the second switch path is configured to provide the high-side charging current as a function of the high-side voltage.

Example 11: The half-bridge circuit of any one of the preceding examples, wherein the second switch path comprises a field effect transistor (e.g. JFET Q2 and/or NFET M2).

Example 12: The half-bridge circuit of any one of the preceding examples, wherein the field effect transistor is a junction field effect transistor (e.g., JFET Q2).

Example 13: The half-bridge circuit of any one of the preceding examples, wherein the second switch path comprises a diode (e.g., diode D2).

Example 14: The half-bridge circuit of any one of the preceding examples, wherein the second switch path comprises a switch (e.g., switch SW2).

Example 15: The half-bridge circuit of any one of the preceding examples, wherein during the power-up state the second switch path is configured to regulate the high-side voltage.

Example 16: The half-bridge circuit of any one of the preceding examples, wherein during a steady state the second switch path is configured to be open circuit.

Example 17: The half-bridge circuit of any one of the preceding examples, further comprising: a low-side holding capacitor (i.e., low-side capacitor C_{BLS}) and a third switch path. The third switch path is configured to provide a low-side charging current (i.e., current I_{CLS}) to the low-side holding capacitor.

Example 18: The half-bridge circuit of any one of the preceding examples, wherein the low-side holding capacitor is configured to provide a low-side holding voltage (i.e., voltage V_{CLS}).

Example 19: The half-bridge circuit of any one of the preceding examples, wherein the third switch path is configured to provide the low-side charging current as a function of the low-side holding voltage.

Example 20: The half-bridge circuit of any one of the preceding examples, wherein during the power-up state the third switch path is configured to regulate the low-side holding voltage.

Example 21: The half-bridge circuit of any one of the preceding examples, wherein the third switch path comprises a field effect transistor.

Example 22: The half-bridge circuit of example 19, wherein the field effect transistor is a junction field effect transistor (e.g., JFET Q3).

Example 23: The half-bridge circuit of any one of the preceding examples, wherein the third switch path comprises a diode (e.g., diode D3).

Example 24: The half-bridge circuit of any one of the preceding examples, wherein the third switch path comprises a switch (e.g., switch SW3).

Example 25: The half-bridge circuit of any one of the preceding examples, wherein during a steady state the third switch path is configured to be open circuit.

Example 26: A method of operating a resonant converter during a power-up state comprises: providing a high-side charging current to a high-side capacitor; and diverting a shunt current (e.g., current I₁) away from a resonant network.

Example 27: The method of any one of the preceding examples, wherein diverting the shunt current away from the resonant network comprises: reducing a resonant capacitor voltage.

Example 28: The method of any one of the preceding examples, further comprising: augmenting a high-side voltage of the high-side capacitor (i.e., element 614).

Example 29: The method of any one of the preceding examples, wherein providing the high-side charging current to the high-side capacitor comprises: regulating a high-side voltage.

Example 30: The method of any one of the preceding examples, wherein the high-side voltage is twelve volts.

Example 31: The method of any one of the preceding examples, further comprising: providing a low-side charging current to a low-side holding capacitor.

What is claimed is:

1. A power converter comprising:
an input node configured to receive an input voltage;
a network comprising an inductor, a capacitor, or both an inductor and a capacitor;
a half-bridge node through which current is provided to the network;
a high-side device coupled between the input node and the half-bridge node;
a low-side device coupled between the half-bridge node and a ground reference;
a high-side driver configured to provide a first drive signal to the high-side device;
a low-side driver configured to provide a second drive signal to the low-side device;
a high-side capacitor configured to supply power to the high-side driver;
a first switch coupled between the half-bridge node and the ground reference and in parallel with the low-side device;
a second switch coupled between the input node and the half-bridge node and in series with the high-side capacitor; and
control circuitry configured to:
turn on the second switch to provide a charging current to the high-side capacitor,
turn on the first switch to augment the charging current, wherein turn-on of the first switch causes a voltage at the half-bridge node to be pulled down to divert a shunt current away from the network, and
keep the first switch turned off after the power converter reaches a steady state, the steady state being conditioned on the high-side capacitor having sufficient charge for the high-side driver to drive the high-side device using the first drive signal.

2. The power converter of claim 1, wherein:
the first switch comprises a first field effect transistor along a first switch path through which the shunt current is diverted away from the network,
the second switch comprises a second field effect transistor along a second switch path through which the charging current is provided to the high-side capacitor, and
the high-side device comprises a third field effect transistor.

3. The power converter of claim 1, further comprising:
a low-side capacitor configured to supply power to the low-side driver,
wherein the steady state is further conditioned on the low-side capacitor having sufficient charge for the low-side driver to drive the low-side device using the second drive signal.

4. The power converter of claim 3, further comprising:
a third switch coupled between the input node and the ground reference and in series with the low-side capacitor,
wherein the control circuitry is further configured to:
turn on the third switch to provide a charging current to the low-side capacitor, and
turn off the third switch responsive to a determination that the low-side capacitor has sufficient charge for the low-side driver to drive the low-side device using the second drive signal.

5. The power converter of claim 4, wherein the control circuitry is further configured to:
limit the charging current of the low-side capacitor to a first current value when a voltage of the low-side capacitor is less than a threshold voltage; and
limit the charging current of the low-side capacitor to a second current value when the voltage of the low-side capacitor is greater than the threshold voltage, the second current value being greater than the first current value.

6. The power converter of claim 3, further comprising:
an auxiliary supply configured to provide a steady state voltage of the low-side capacitor; and
a bootstrap diode configured to provide a steady state voltage of the high-side capacitor using the steady state voltage provided by the auxiliary supply.

7. The power converter of claim 1, wherein the control circuitry comprises a control circuit configured to:
compare a voltage of the high-side capacitor to a threshold voltage, the threshold voltage being less than a steady state voltage of the high-side capacitor; and
provide a control signal to the second switch based on a result of the comparison, wherein the control signal turns on the second switch when the voltage of the high-side capacitor is less than the threshold voltage, and wherein the control signal turns off the second switch when the voltage of the high-side capacitor is greater than the threshold voltage.

8. The power converter of claim 7, wherein:
the threshold voltage corresponds to a peak voltage of the high-side capacitor during a period in which the first switch is turned on to augment the charging current, and
the control circuitry is further configured to use the control signal to limit the voltage of the high-side capacitor to the peak voltage until the power converter reaches the steady state.

9. The power converter of claim 7, wherein the control circuit comprises a comparator referenced to the voltage at the half-bridge node, the comparator comprising an inverting input that receives the voltage of the high-side capacitor and a noninverting input that receives the threshold voltage.

10. The power converter of claim 1, wherein:
the high-side device comprises a field effect transistor, and
the steady state is conditioned on the high-side capacitor having sufficient charge to provide for turn-on and turn-off of the field effect transistor when the first drive signal is applied as a gate voltage to a gate of the field effect transistor.

11. The power converter of claim 1, wherein the network is a resonant network comprising an inductor coupled in series with a capacitor.

12. A half-bridge circuit in a power converter having a high-side driver, a low-side driver, and a network with an inductor, a capacitor, or both an inductor and a capacitor, the half-bridge circuit comprising:
a half-bridge node coupled to the network;
a high-side device coupled between an input node of the power converter and the half-bridge node, wherein the high-side device is configured to receive a first drive signal provided by the high-side driver;
a low-side device coupled between the half-bridge node and a ground reference, wherein the low-side device is configured to receive a second drive signal provided by the low-side driver;
a high-side capacitor configured to supply power to the high-side driver;
a first switch coupled between the half-bridge node and the ground reference and in parallel with the low-side device; and
a second switch coupled between the input node and the half-bridge node and in series with the high-side capacitor, wherein:
the first switch is configured to turn on in response to a first control signal to augment a charging current by causing a voltage at the half-bridge node to be pulled down to divert a shunt current away from the network, and
the second switch is configured to turn on in response to a second control signal to provide the charging current to the high-side capacitor, and
the first switch is configured, using the first control signal, to remain turned off after the power converter reaches a steady state, the steady state being conditioned on the high-side capacitor having sufficient charge for the high-side driver to drive the high-side device using the first drive signal.

13. The half-bridge circuit of claim 12, further comprising:
a low-side capacitor configured to supply power to the low-side driver,
wherein the steady state is further conditioned on the low-side capacitor having sufficient charge for the low-side driver to drive the low-side device using the second drive signal.

14. The half-bridge circuit of claim 13, further comprising:
a third switch coupled between the input node and ground reference and in series with the low-side capacitor,
wherein the third switch is configured to turn on in response to a third control signal to provide a charging current to the low-side capacitor, and
wherein the third control signal is configured to turn off the third switch when the low-side capacitor has sufficient charge for the low-side driver to drive the low-side device using the second drive signal.

15. The half-bridge circuit of claim 14, wherein the third control signal is further configured to:
limit the charging current of the low-side capacitor to a first current value when a voltage of the low-side capacitor is less than a threshold voltage; and
limit the charging current of the low-side capacitor to a second current value when the voltage of the low-side capacitor is greater than the threshold voltage, the second current value being greater than the first current value.

16. The half-bridge circuit of claim 13, further comprising:
a bootstrap diode configured to provide a steady state voltage of the high-side capacitor using a voltage provided by an auxiliary supply of the power converter,
wherein the voltage provided by the auxiliary supply corresponds to a steady state voltage of the low-side capacitor.

17. The half-bridge circuit of claim 12, wherein the second control signal is configured to:
turn on the second switch when the voltage of the high-side capacitor is less than a threshold voltage, the threshold voltage being less than a steady state voltage of the high-side capacitor; and
turn off the second switch when the voltage of the high-side capacitor is greater than the threshold voltage.

18. The half-bridge circuit of claim 17, wherein:
the threshold voltage corresponds to a peak voltage of the high-side capacitor during a period in which the first switch is turned on to augment the charging current, and
the second control signal is further configured to limit the voltage of the high-side capacitor to the peak voltage until the power converter reaches the steady state.

19. The half-bridge circuit of claim 12, wherein:
the high-side device comprises a field effect transistor, and
the steady state is conditioned on the high-side capacitor having sufficient charge to provide for turn-on and turn-off of the field effect transistor when the first drive signal is applied as a gate voltage to a gate of the field effect transistor.

20. The half-bridge circuit of claim 12, wherein the network is a resonant network comprising an inductor coupled in series with a capacitor.
